(19) United States
(12) Patent Application Publication
(10) Pub. No.: US 2015/0142256 A1
(43) Pub. Date: May 21, 2015

(54) METHOD AND SYSTEM FOR FACILITATING SERVICE AT SERVICE CENTERS

(71) Applicant: Emanuel D. Jones, Ellenwood, GA (US)

(72) Inventor: Emanuel D. Jones, Ellenwood, GA (US)

(21) Appl. No.: 14/605,102

(22) Filed: Jan. 26, 2015

Related U.S. Application Data
(63) Continuation-in-part of application No. 14/112,695, filed on Oct. 18, 2013.
(60) Provisional application No. 61/477,079, filed on Apr. 19, 2011.
(60) Provisional application No. 61/931,111, filed on Jan. 24, 2014.

(51) Int. Cl. G07C 5/00

(52) U.S. Cl. CPC G07C 5/008
USPC 701/31.4

(57) ABSTRACT

Methods and systems for improving the efficiency of vehicle servicing at a vehicle service center are described. A customer identifies a vehicle on a smart device. A service history for the vehicle is retrieved and transmitted to the smart device. The customer, using the smart device, identifies a concern with the vehicle. Diagnostic solutions are determined for the vehicle using the customer identified concern. A service report is generated that includes the diagnostic solutions along with prices for each diagnostic solution presented. A repair order is generated by a system having manufacturer information about the vehicle being accessed.

### RELATED APPLICATION DATA

This is a Continuation-In-Part application of U.S. Non-Provisional patent application Ser. No. 14/112,695, filed Oct. 18, 2013, which is a U.S. National Stage application of Patent Cooperation Treaty Application Ser. No. PCT/US12/34328, filed Apr. 19, 2012, which claims priority to U.S. Provisional Patent Application Ser. No. 61/477,079, filed Apr. 19, 2011, all of which are incorporated herein by reference. This application claims priority to U.S. Provisional Patent Application Ser. No. 61/931,111, filed Jan. 24, 2014, which is incorporated herein by reference.

### FIELD

This disclosure generally relates to a computer-implemented method and system for improving the interaction of the customer with the service center.

### BACKGROUND

Traditionally, a customer takes a vehicle to a service center when they have a concern about the vehicle. Once at the service center, the customer relays the concern to a technician that inspects the vehicle to determine what is wrong. Upon determining the issue, the technician may need to order out-of-stock parts prior to being able to fix the vehicle. Each step of this process takes time that is burdensome on both the customer and the technician.

### SUMMARY

This disclosure includes a method for self-service by a customer during a visit to a vehicle service center.

One embodiment includes a method comprising: providing identification information of a vehicle via a console located at the service center, the console comprising a touch-screen display device, after confirming the identification information, verifying personal information from the customer via the console and updating the personal information at the console; accessing a database to obtain vehicle history data corresponding to the vehicle; querying concerns of the customer, the concerns are related to the vehicle; displaying recommendation for the vehicle based on the concerns and preventative measure that are upcoming for the vehicle on the console; displaying the preventive measures that are overdue for the vehicle on the console; and notifying a technician that the customer has checked into the service center and the vehicle is ready for inspection and further processing by the technician. The method can include the step of generating a repair order from a dealership management system. A system including the parts and steps herein may be also prepared.

An aspect of the present disclosure relates to a method for improving the efficiency of vehicle servicing at a vehicle service center. The method includes receiving a search criterion identifying a vehicle from a smart device and retrieving vehicle history records for the vehicle from a vehicle history database. The method further includes receiving a concern related to the vehicle from the smart device and retrieving diagnostic solutions correlated with the concern from a diagnostic solutions database. Moreover, the method includes generating a service report that includes the diagnostic solutions and prices for each diagnostic solution. Additionally, the method includes preparing a repair order after a secondary system having information specific to the vehicle's manufacturer is queried.

The search criterion may include a vehicle year, vehicle model, vehicle mileage, and/or a driver's license number. The concern may be for a vehicle defect or a service selected from available services indicated to the customer. The method may further include forwarding the service report to a technician and receiving recommendations from the technician. The recommendations may be based upon an examination of the vehicle and the service report. The method may also include transmitting the recommendations to the smart device for approval by the customer and receiving, approval for at least a portion of the recommendations. Additional services performable on the vehicle and based upon the vehicle history records may be determined. It may also be determined whether the vehicle has any outstanding recalls to be performed. A supplemental report, that evidences the additional services and outstanding recalls, may be transmitted to the smart device. The service report may be transmitted to a parts department that determines needed parts, pricing of parts, availability of parts, locations of the parts, and discounts to be applied. Moreover, the method may include receiving a pre-payment from the smart device. The pre-payment may be for parts and/or services to repair the vehicle.

Another aspect of the present disclosure relates to a method for automating routine servicing of a vehicle. The method includes receiving a service from a smart device. The service is selected from a list of services to be performed on the vehicle. The list of services are included within a services database that is accessible by the smart device. The services database is in communication with a dealer management system having information specific to the vehicle. The method further includes correlating the received service with information included within the services database, and generating a repair order report. The method may also include transmitting instructions to a technician to perform the received service on the vehicle.

Yet another aspect of the present disclosure relates to a system for improving efficacy of vehicle servicing. The system includes a smart device that receives vehicle information from a customer, and a technician device in communication with the smart device that allows a technician to review the vehicle information. The system further includes a vehicle database in communication with the device that includes information related to vehicles. The vehicle database is included within a dealer management system that is in communication with service centers. Additionally, the system includes a services database in communication with the smart device, the technician device, and the dealer management system. The services database includes service history that is specific to the vehicle and that is communicable to the service centers over the dealer management system upon request and authentication. Moreover, the system includes a service report generator that generates a service report based on the vehicle information and information provided by the technician.

An additional aspect of the present disclosure relates to a method for self-service by a customer during a visit to a vehicle service center. The method includes a smart device transmitting vehicle identifying information and the smart device transmitting customer information corresponding to the vehicle identifying information. Moreover, the smart device accesses a vehicle history database that include vehicle history information specific to the vehicle. The vehicle history database is in communication with a dealer management system. The method further includes the smart device transmitting a concern about the vehicle. The smart device also receives a recommendation for the vehicle based on the concern, overdue services of the vehicle, and comments of a technician. The overdue services are determined from the vehicle history information and a suggested services list included within the dealer management system. Furthermore, the smart device transmits the recommendation to a server database that is in communication with vehicle service centers.

The recommendation may be communicable from the server database to the vehicle service centers upon request and authentication. The concern about the vehicle may be depicted on a customer alterable pictorial representation of the vehicle. The method may further include the smart device receiving warrantee information specific to the vehicle.

### BRIEF DESCRIPTION OF THE FIGURES

The detailed description particularly refers to the accompanying figures in which:

FIG. 1 is a flow diagram outlining one illustrative embodiment,

FIGS. 2A, 2B, 2C, and 2D show an exemplary feature of specific embodiments,

FIG. 3 shows a flow diagram outlining an illustrative embodiment,

FIGS. 4A, 4B, and 4C illustrate the rapid intake feature of specific embodiments,

FIG. 5 shows illustrative steps of one specific embodiment,

FIG. 6 shows an example of a console,

FIG. 7 shows a flow diagram outlining an illustrative embodiment.

FIGS. 8A and 8B show an illustrative embodiment in which a central server can communicate with the console(s), the dealership database, and the dealerships,

FIG. 9 shows a block diagram, showing certain method in the context of an illustrative body shop scenario,

FIG. 10 shows an exemplary vehicle repair and service history from a specific embodiment, and

FIGS. 11A-11D show screenshots of a mobile application according to specific embodiments.

### DETAILED DESCRIPTION

Exemplary, non-limiting, embodiments of the present disclosure are discussed in detail below. While specific configurations are discussed to provide a clear understanding, it should be understood that the specific embodiments and their respective configurations are provided for illustration purposes only. A person skilled in the relevant art will recognize that other configurations may be used without departing from the spirit and scope of the disclosure.

One embodiment of the present disclosure is an automated and computer implemented method for facilitating and providing services to a customer at dealerships or repair centers. This method includes, providing a console having a processor; providing a database having vehicle history records; receiving at least one search criterion from a customer to identify his vehicle; retrieving the vehicle service records for the vehicle identified as satisfying the at least one search criterion; identifying a service record in the database, the service record being indicative of ownership of the vehicle; receiving from the customer any concerns or requests related to a vehicle defect or a selected service selected from available services; generating a service report, (e.g., using the Dealership Management System) based (i) on the correlation between the diagnostic information and a database of diagnostic solutions, and (ii) the prices of the selected services; forwarding the service report to a technician for review; and collecting the vehicle from the customer. In certain examples, the method and system can make use of data, including service codes, in the Dealership Management System, which are currently available in the industry (e.g. in the vehicle industry by Remolds and ADP).

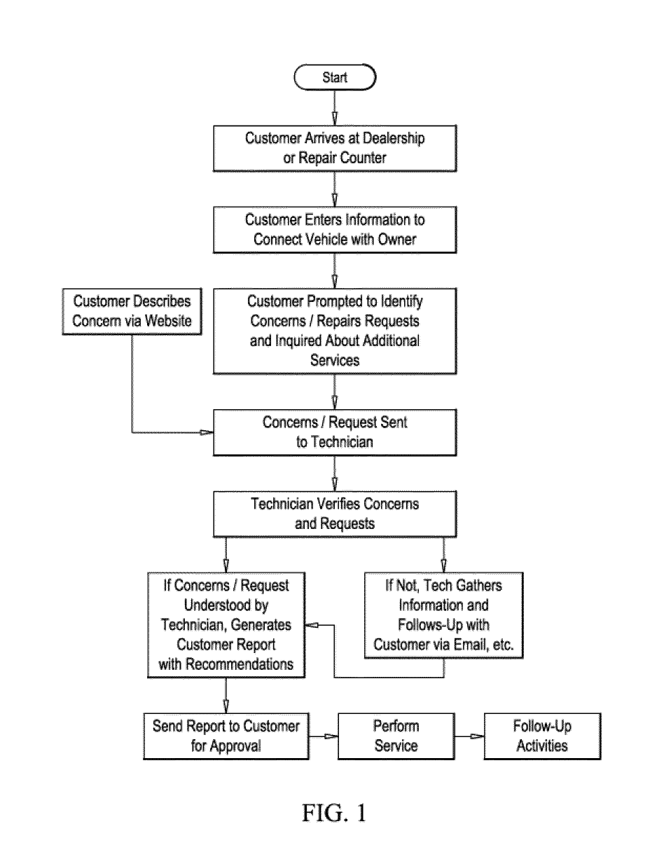

FIG. 1 is a flow diagram outlining one method embodiment. The block flow diagram illustrates a series of steps that can be performed according to one specific embodiment. These steps can be modified, added, omitted, or rearranged depending on the particular embodiment.

The flow diagram represents a method of utilizing a module, which can reside near or in a dealership service center, to collect and communicate information from the customer about the vehicle. The console or vending device can act as a totally stand-alone unit to vend actual services or facilitate the provision of services. The module may be web-based, utilizing the Internet and a number of graphical user interfaces (GUIs) to communicate with an individual or entity that triggers the collection and communication of information. In one example, the individual or entity may begin by inputting information that allows the dealership to recognize the vehicle is connected with that individual or entity. The console or input device provides a point of access between the dealership and the customer.

According to one embodiment, a method and system using a module begins with a customer arriving at a dealership or repair center so that repair work can be performed on the customer's vehicle. Upon arriving, the customer arrives to a console that allows the customer to enter certain identifying information about the customer and the associated vehicle. In the arrangement, the customer enters information that allows the system to identify the vehicle and the customer providing the vehicle to the dealership or repair center.

For example, the customer may enter his name (full or partial) and address together with the vehicle identification number from his or her vehicle. Other identifying information may include year/model, mileage, driver's license number, or any other information that allows the system to connect the vehicle with the customer. It should be noted, although the present embodiment includes a card reader for security purposes, it would be clear to one of skill in the art that such security measures may be dispensed with if desired. For example, instead of providing an identification card to the system, a customer could be requested to merely enter his or her name or other identifying information on the touch-screen display and the customer's individual vehicle-related data could be accessed and processed, accordingly. For another example, instead of providing a vehicle identification card, the customer could use his or her credit card, which would in turn generate a list of connected vehicles.

After this verification, the customer is guided to enter the reason or concern for visiting the dealership or repair center. There can be a graphic user interface that allows the customer to enter or identify the reason for the visit. In one example, the console provides a multi-point image or diagram that allows the customer to identify concerns about the vehicle and identify various services the customer would like have performed to his or her vehicle.

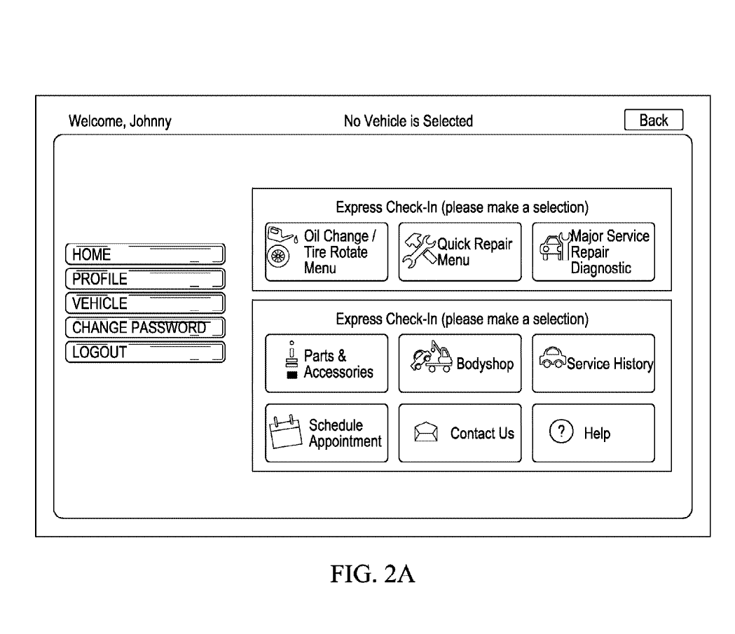

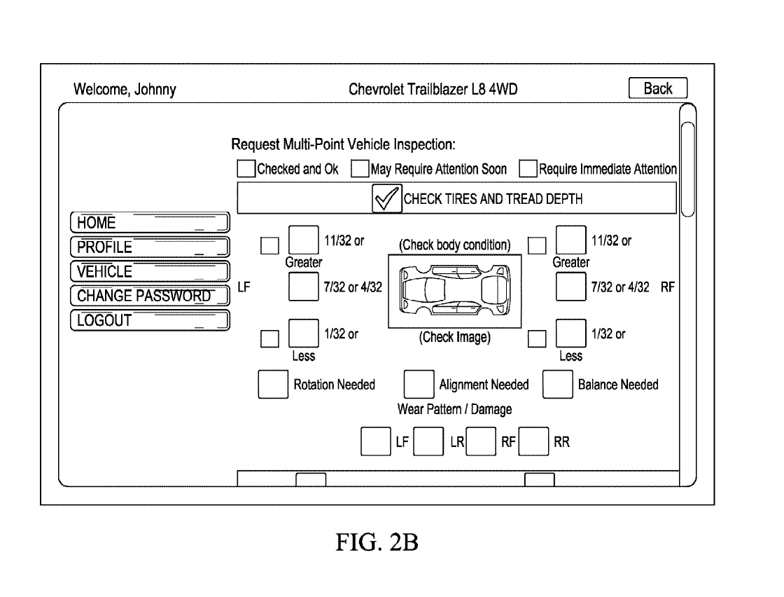

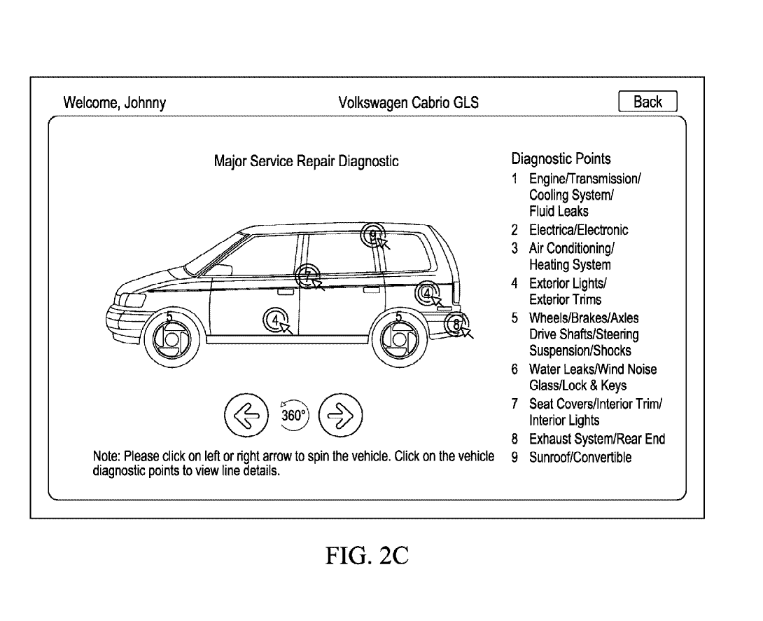

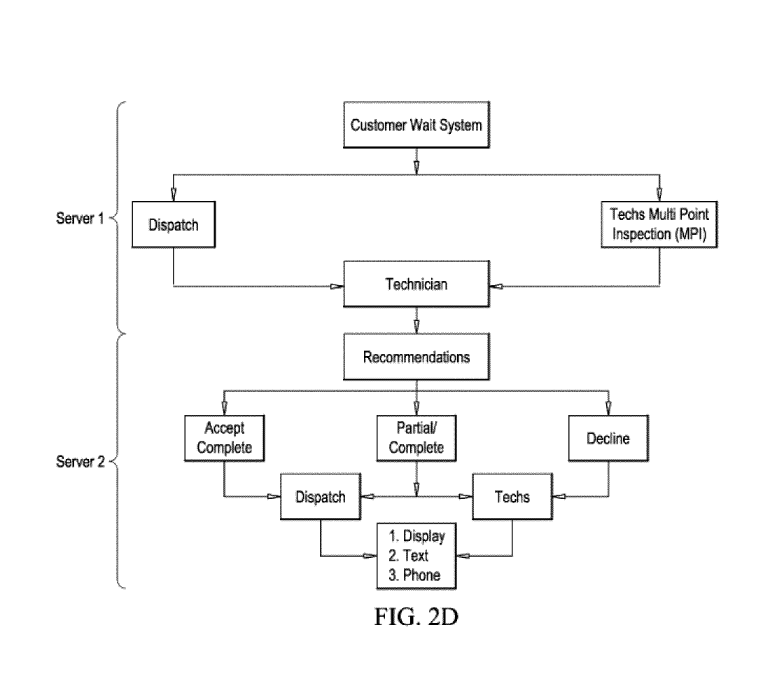

FIGS. 2A, 2B, and 2C show an exemplary arrangement in which a customer can enter information related to the purpose of the visit, which could include routine visits such as tire rotation, oil and filter service, etc. A customer can enter whether the visit is related to a specific timed-visit, such as a 5,000 mile visit. As shown in FIG. 2A and FIG. 2B, there can be other pre-set categories such as “oil change,” “tire rotation,” a “battery performance inspection,” a “brake inspection,” and others. As shown in FIG. 2C, if the problem does not fit into a particular category, the customer could be prompted by the system to describe the reason for the visit or the particular problem with the vehicle or to identify specific diagnostic points on the vehicle. The customer may also include the method by which he or she would like to be contacted by the dealership or repair center, whether the customer would like to pre-pay for certain services, and whether the customer would like to wait-on or drop-off the vehicle with the dealership.

In one embodiment, an expert repository of repair recommendations can be used to show various recommendations to the customer based on the inputs. These recommendations include: suggested repairs based on operational and/or failure information extracted from symptoms reported by the customer, or planned maintenance actions, or field modifications or upgrades. The recommendation can include suggested trouble shooting actions to further refine the repair recommendation. The customer can also be prompted with factory recall recommendations.

After the customer enters the appropriate information, the vehicle can be logged into the dealership or repair center. In one embodiment, a porter can greet the customer, confirm that the vehicle is the vehicle identified by the customer, and can porter the vehicle to the service center. The customer may be given a receipt for proof that the vehicle was left at the dealership or repair center and a copy of the information entered by the customer.

As shown in FIG. 2D, the information provided by the customer is integrated with information stored in the servers (including, e.g. a dealership management system) and provided to a technician. More particularly, the information entered by the customer at the modules can be transmitted to the technician that will be inspecting the vehicle and may be working on the vehicle.

In one embodiment, the information is presented to the technician in a manner similar to the manner presented to the customer. The technician console generates a logon for display on a computer or console assigned to the technician. After verification, the technician's console provides the technician with the information as entered by the customer, which may be in the form of a customer's report. In this embodiment, the customer's report may include the information as entered by the customer.

In one embodiment, a customer's report is forwarded to a technician, who can then review the report together with the vehicle. The customer's report may be integrated with historical information about the vehicle (e.g. past visit complaints or repairs). The technician can compare the customer's report and the vehicle and then provide recommendations on a plan to address the customer's issues or concerns.

After the technician reviews the customer's report, the technician can contact the customer with recommendations on a course of action. For example, the technician may suggest servicing the vehicle so as to address the concerns of the customer and/or may suggest additional services. The technician also may start to work on the repair(s) requested or approved by the customer. Other computer devices can also be utilized, including, but not limited to, a desktop computer, a notebook computer, tablet computer, a personal digital assistant (PDA), or any other data processing device. In certain embodiments, the contact can be initiated via a telephone call. After the technician has made the recommendation, the customer then can log into a website (e.g., through a smart phone) and confirm or reject any recommendations. Further, the customer may ask questions about the recommendations.

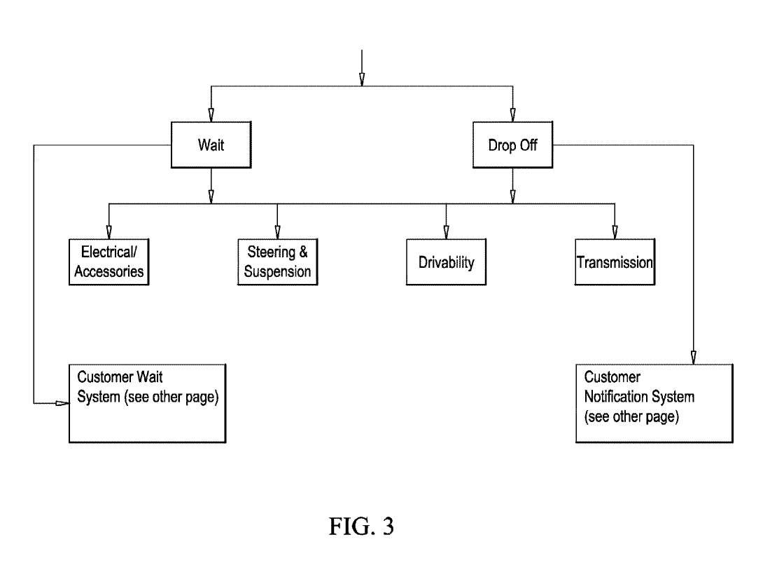

In another embodiment, such as shown in FIG. 3B, the customer may be given the option of whether to “wait-on” or “drop-off” the vehicle. For example, if the issues are related to electrical or steering issues, it may be feasible for the customer to “wait-on” the vehicle as the repairs may take less than a few hours. If the customer opts to “wait-on” on the vehicle, there can be displays at the service center that update the customer on the vehicle's status. If the customer opts to “drop-off,” the customer may be notified by email or text message (or similar communication) as to the status of his or her vehicle.

After the customer confirms the recommendations or parts of the recommendations, a service order will be generated for the technician to perform the services and for the parts department to arrange for the parts to be delivered to the technician. In the situation where the servicing will need parts, the customer may be asked to pre-pay for these parts using the website. Once parts are ordered, the ordered parts can be tracked as active and historical parts orders for a vehicle (e.g., whether shipped on back order and the quantity ordered). The tracking function can be driven by the YIN or by the order number or the part number. The technician can also begin servicing the vehicle.

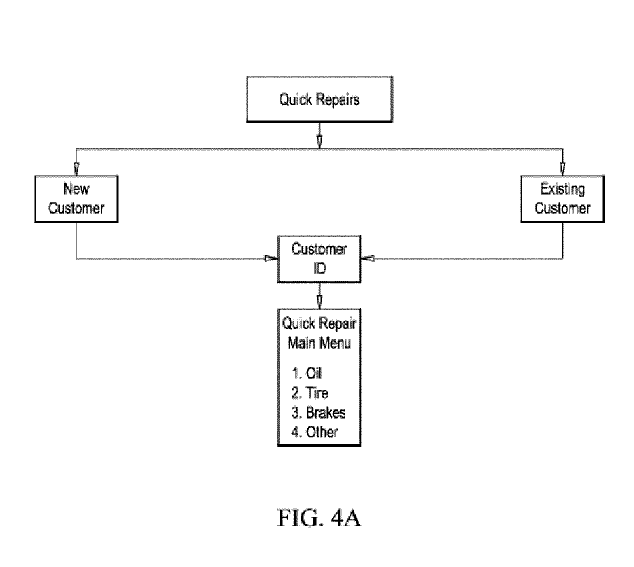

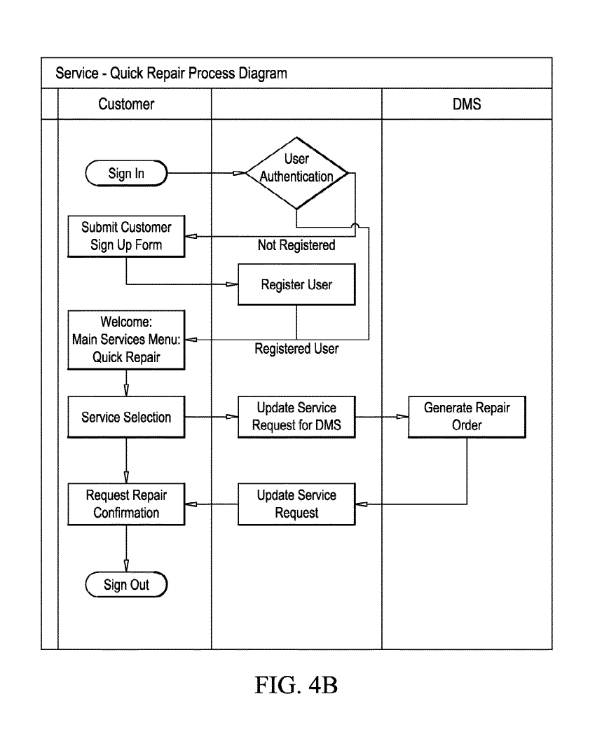

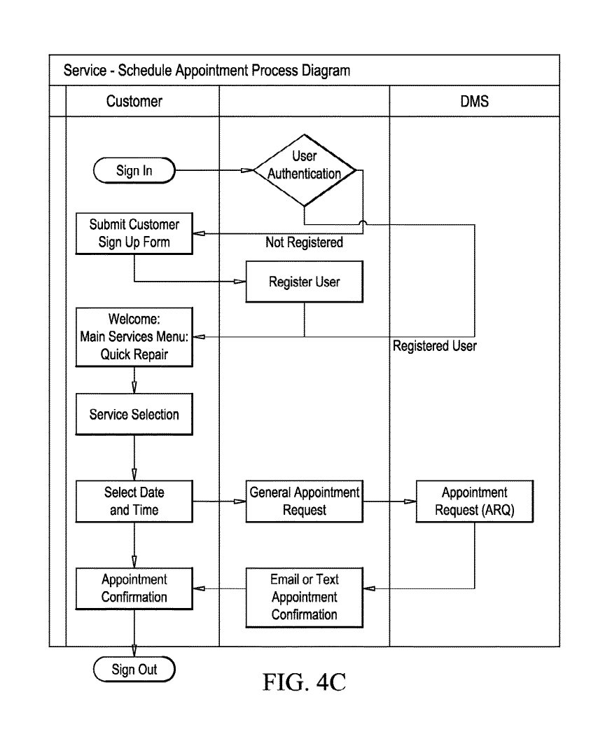

In another embodiment, such as shown in FIG. 4A and FIG. 4B, the console can provide the customer with a rapid intake process. In this arrangement, the customer first identifies his or her vehicle in the database by entering such identifying information. After the system identifies the customer (e.g., in the central server or cloud arrangement) (as either a new customer or an existing customer), then the customer is guided through a quick set of options for standard repairs or preventative maintenance. In one example, the customer is provided with the option of an oil change, tire rotation, or brake repair. FIG. 4A shows an exemplary process diagram or flow chart of the system and method in which the customer begins signing in and then is moved through various steps. A repair order can be generated using the dealership management system as if a traditional service had entered the data to generate such a report.

In another embodiment, the system allows the customer to submit data to the dealership about any issues and concerns about the vehicle from a remote terminal. In this embodiment, the customer logs onto his or her account, and the customer identifies the concerns or issues with the vehicle. In this arrangement, this information can be entered from a remote computer prior to visiting the dealership, which saves time for the customer as well as the dealership. In this arrangement, the customer arrives at the dealership and is almost ready to “wait on” or “drop-off” the vehicle with the repair center or dealership.

The method can include aspects to assist in customer and dealership communication. For example, FIG. 4C shows an example of a customer using the method and system to generate an appointment that is logged into the dealership management system. If additional issues are discovered during the course of performing the services, the technician can contact the customer electronically and ask the customer to confirm the additional services. This additional step can reduce any customer irritation and disputes. Just as relevant, this communication can allow the technician to more rapidly work or begin working on the vehicle, which can improve efficiency.

At any point, the customer can be prompted to determine or assist in the determination of whether the service is a covered service (e.g. insurance or warranty). For example, in the case of a body shop, the dealership or the repair center can forward the repair order directly to the insurance company for approval. Alternatively, the customer may simply approve the submission of the service or repair to the factory warranty process. Warranty information can also be accessed by the customer. By entering the relevant information, the customer can view all warranty information about that vehicle and its components. All warranty claims and insurance claims can also be submitted and tracked using certain embodiments.

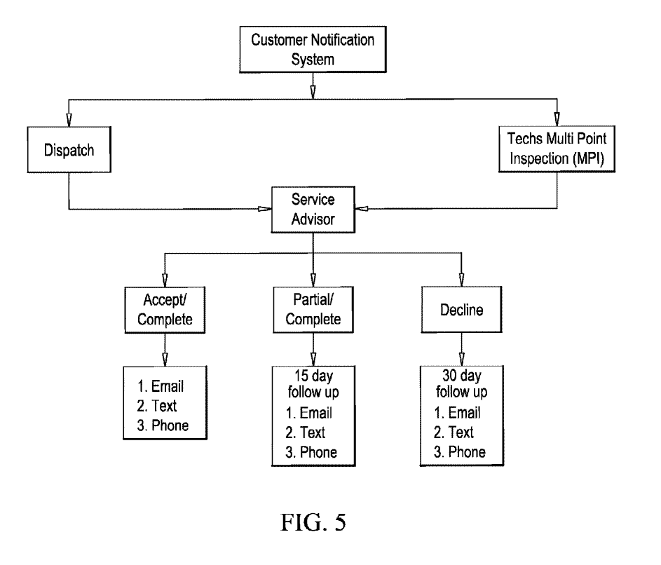

In another embodiment, such as shown in FIG. 5, the method can include the steps to follow up on the customer's choices. In the event that the customer chooses not to follow certain recommendations of the technician, the dealership through the system can follow up with the customer at certain intervals. For example, if the customer chooses not to have certain recommendations performed on his vehicle, then the follow-up step may be a phone or text message that reminds the customer to perform such services. This step may be performed at 15 days or at 30 days or at some other increment.

It is contemplated that the follow-up step may include a pecuniary incentive to bring the vehicle back to the service center to execute the recommendation. Further, the dealership can provide an incentive (e.g., a discount) to entice the customer to follow the recommendation. This provides a computer-implemented system for managing the process of following-up on a customer's dealership experience and needs.

Embodiments can be implemented using traditional computers, servers, and network connections. For example, a computer system can include one or more dealer computers, one or more web servers, one or more application servers, one or more proxy servers, one or more landing servers, and/or one or more extranet servers (used within an external partner's secure environment) and one or more service management (SM) servers, and network connections linking computers and servers. In certain embodiments, the method can be implemented in such a manner that more than one server can be combined into one server. It should be understood that the network connection between servers can include the Internet. Non-limiting examples of computer networks suitable for application to the present disclosure include local area networks (LANs), wide-area networks (WANs), and mixtures thereof.

In accordance with one embodiment, a system employing a number of individual consoles is provided. The consoles are each connected in a Local Area network (LAN) configuration with a server which is, in turn, connected via two-way communications links, to various databases. The LAN can be a wireless LAN (WLAN) or it can use cables to interconnect each device using Ethernet, i.e., in accordance with the IEEE 802.3 standard, or other suitable cabling and data delivery technology. The connection from the server to the database systems can be made via a web-based database query system, which is a relational database management system or any other suitable communication link.

Consoles are located, for example, in the reception area of a service center facility. When a customer (not illustrated) enters a facility that is equipped with a system, the customer may be greeted by a number of consoles, each spaced apart from one another in order to afford the customer a certain level of privacy as he or she answers the questions displayed on the screen. Accordingly, because a number of individual consoles are provided, the customer may not be required to wait in a line for service.

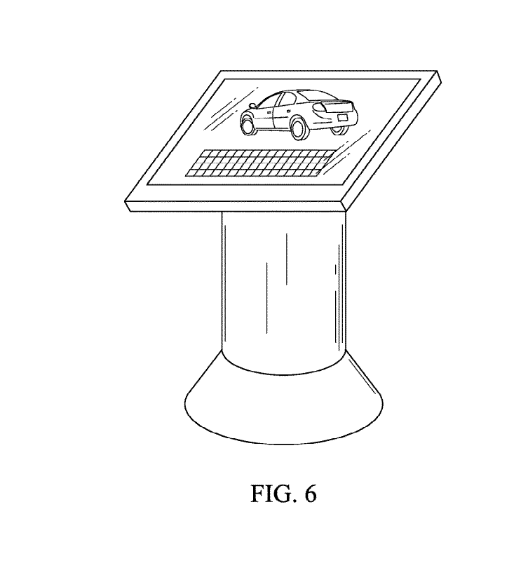

As mentioned above, an example of a console in accordance with the present disclosure is illustrated in FIG. 6. The console illustrated in FIG. 6 includes a stand (or housing) holding a computer (or other processing device) that interacts with a database via a server, creates the user interface, prints out documents as requested, and intakes identification information and other user provided information. According to one embodiment, the stand also houses a printer (not illustrated) and supports a monitor that can be a touch-screen or a regular monitor with keyboard or other data entry device connected, and a card reader, or other information reader such as a magnetic pad, with each of these components connected to the computer located at the console. The computer executes software to implement the system, as discussed above, and to interact with the customer, database(s), and dealership staff.

The computer and servers, including central servers, can communicate with one another through network connections and protocols. A dealer computer can be in communication with a web server such that outbound requests and inbound responses can be received and transmitted, respectively, by a computer and web server. A web server can be in communication with an application server such that outbound requests and inbound responses can be received and transmitted, respectively, by servers, through a port connection, utilizing a TCP-IP communication protocol via the Internet, including XML. An application server can be in communication with a proxy server such that outbound requests can be transmitted server to server, through the use of Http protocol.

FIGS. 3 through 5 are block flow diagrams depicting method embodiments. It should be understood that the block flow diagrams illustrate series of steps that can be performed according to certain embodiments. Such steps may be modified, added, omitted, or rearranged depending on the particular embodiment of the present disclosure.

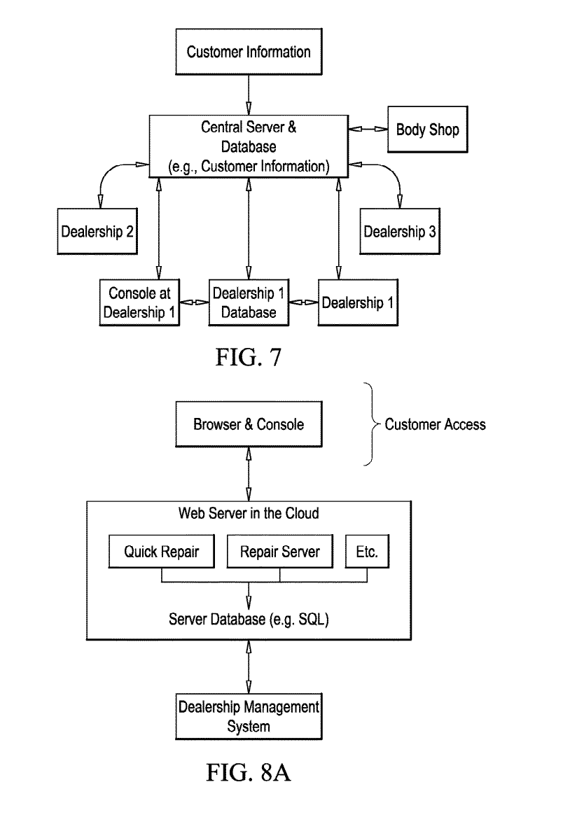

FIG. 7 shows an illustrative embodiment in which a central server can communicate with the console(s), the dealership database, and the dealerships (e.g. dealership 1, 2 or 3) through network connections and protocols. In this embodiment, information from the console can be communicated to a central server, and this information can be used to update a networked dealership database or computer. This type of embodiment can allow the central server to update information available in the database and to the dealership. For example, when a customer updates his or her vehicle or personal information in the central server (directly or indirectly) or when the customer's information has been updated from other sources, the central server can push that information to networked dealership computers and databases. As has been shown, the dealership may elect to access or obtain directly from the central server, which may be operated by a third party. As shown, the data at the central computer could be accessed from the console, e.g., in a controlled matter, as discussed above.

The central server and database may be hosted remotely in third party servers and controlled by a separate third party, who administers the system. In this example, dealership 1 can obtain information from the central server that has been updated by the customer at the central server or by information from other networked dealerships or other sources. As more dealerships and parties join the network, the availability of data increases and the value of the central database increases. In one example, dealerships would pay fees to join the network of dealerships and data between networked dealerships could be shared. Also, networked dealerships can have access to updated customer information.

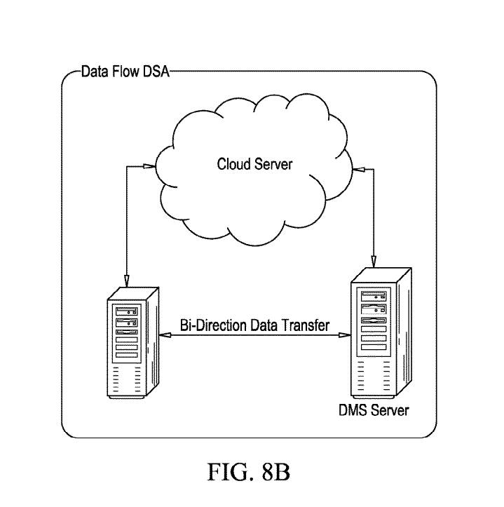

FIG. 8A shows an example of the portal architecture and system. In this example, the main method is to enable dealerships (e.g., Dealership Management System) to connect to a data transfer server that mediates access to the data resources. The method and system can enable dealerships to have complete, customized access to their customer and services data. This can help them in serving and reaching their customers effectively and efficiently. FIG. 8B shows an example of the system and illustrates cloud aspects of certain specific embodiments.

While certain embodiments have been disclosed in the context of vehicles, many embodiments may be used with service centers that service snowmobiles, boats, lawn equipment, airplanes, and heavy machinery. Other mechanisms are contemplated by the present disclosure as long as they are capable of being repaired and inspected. Non-limiting examples include automotive systems (e.g. a brake system, a transmission, or engine), snowmobiles, airplanes, and heavy machinery. Users of the module include, but are not limited to, individuals and entities (otherwise referred to as customers) requesting repair or inspection by repair center employees.

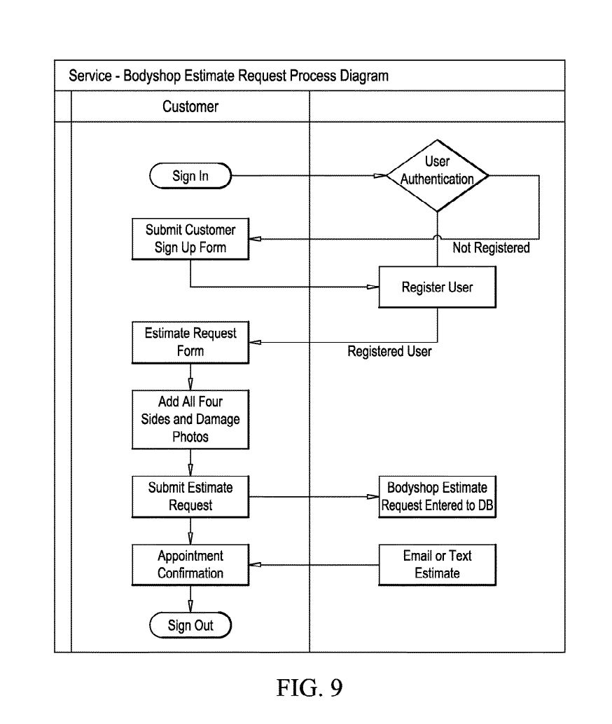

It is contemplated that the methods and systems may be used in services centers, including body shop services centers. FIG. 9 shows a block diagram involving an illustrative body shop scenario. In this arrangement, the customer can access the console and then provide information about his or her vehicle. The system can then provide specific information about the repair.

In other embodiments, the contact can be initiated by automatically transmitting a survey to a customer's e-mail address. This alternative may be utilized if data stored in the SM server indicates that the customer prefers e-mail contact. The e-mail contains a request to conduct a survey via a web link that is provided. Once the individual clicks on the web link, a survey GUI generated by the follow-up module and hosted by application server is displayed for completing the survey.

In certain cases described above, after telephone or e-mail contact, a dealer can identify a trigger value wherein a customer's response may trigger the follow-up module to automatically generate a customer contact file for further processing and resolution. For example, any dissatisfaction may trigger the generation of a customer contact file.

In other embodiments, the contact can be initiated by automatically transmitting a survey to a customer's e-mail address. This alternative may be utilized if data stored in the SM server indicates that the customer prefers e-mail contact. The e-mail contains a request to conduct a survey via a web link that is provided. Once the individual clicks on the web link, a survey generated by the follow-up module and hosted by the application server is displayed for completing the survey. After telephone or e-mail contact, a dealer can identify a trigger value wherein a customer's response may trigger the follow-up module to automatically generate a customer contact file that is transmitted for further processing and resolution. For example, any dissatisfaction may trigger the generation of a customer contact file.

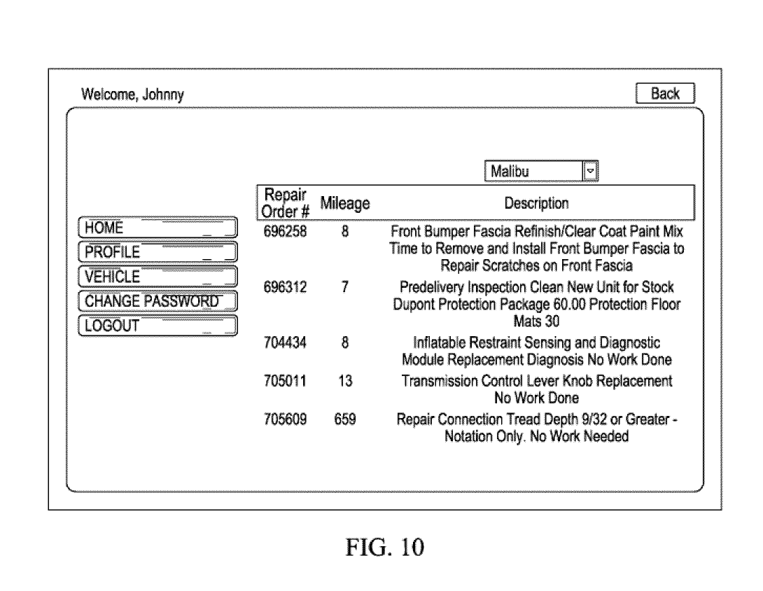

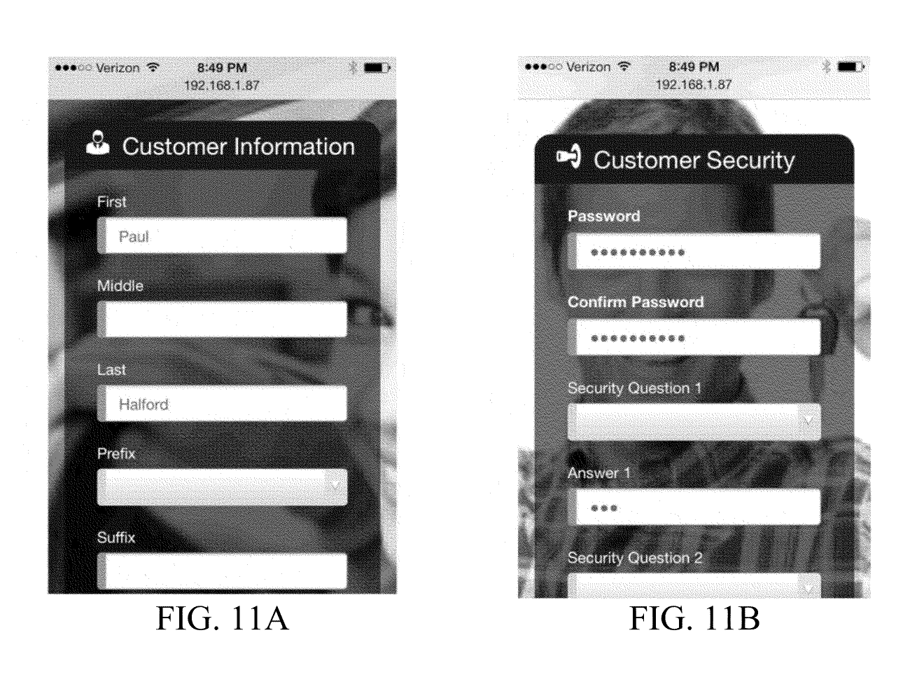

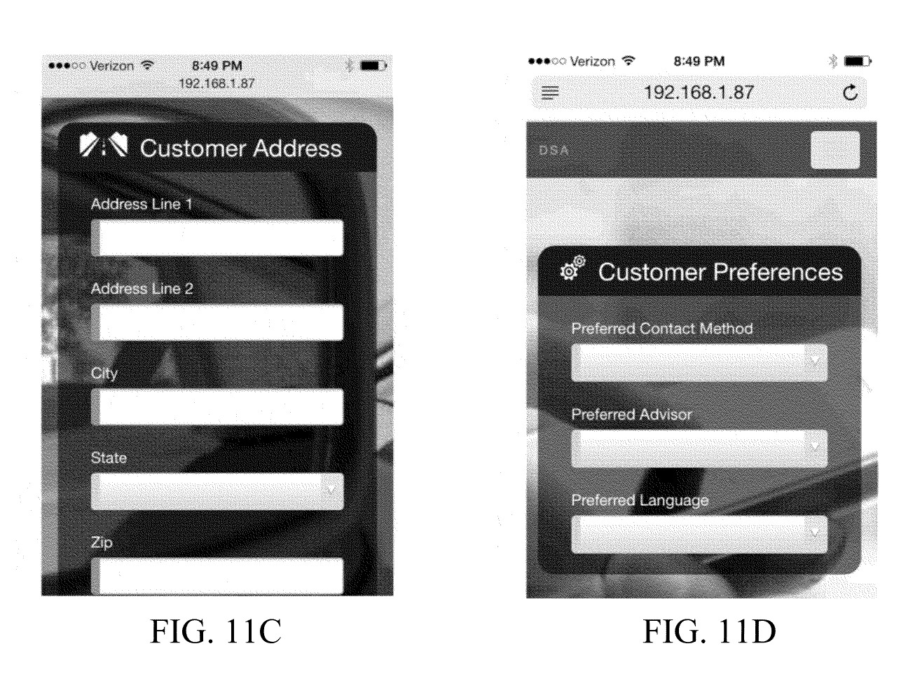

In another embodiment, the method and system provides a mechanism to allow a customer to easily access and view the service records of a vehicle. By logging onto a website, the customer can review the history of a vehicle's repairs and service history (e.g., FIG. 10). By automating the interaction between the customer and the technician (or the dealership), it is possible to create a record of all of the repairs, concerns, services, or other issues arising with the vehicle. If a customer reviews the records and notices a discrepancy, he or she can contact the dealership or service center to resolve the issue. Further, there can be an option to allow the customer to enter information about a specific service that was performed by third-party servicers, and this entry can be marked “as customer entered” or the like. In such case, there can be an option for the customer to upload the receipt of the third-party services to authenticate that the service was in fact performed. It also is possible that a set of dealerships may agree to share service information, which will allow for a more complete history of the vehicle.

This information could be transferred to third parties in certain arrangements. In one embodiment, the dealership or service center may offer to provide a “certified copy” of this history for the owner of a vehicle to provide to a third party. Further, a dealership or service center may agree to directly transfer the history to a subsequent owner of a vehicle.

In another embodiment, the method and system can include advertising. This feature presents itself in two ways: first the way the console looks (the presentation format), and second through an advertising screen that can run continuous paid advertisements such as loop-advertisements. The first feature allows the machine to have changeable front plates or other parts to tailor its look and feel. The same console could be made to look like a cellular telephone, a bank ATM, a candy machine, drug store or any other presentation format. A particular service provider's name can also appear on the exterior of the changeable plate. In particular, the console of the present disclosure can be equipped with a front-loading vending apparatus. A remote station can send advertisements to a large number of consoles on a network. Each console can run the same advertisement, or different machines could be sent different advertisements.

This disclosure further includes a computer-implemented method for improving the efficiency of vehicle servicing at a vehicle service center. The method includes providing a smart device located away from the service center, providing a server database having vehicle history records, receiving at least one search criterion from a customer identifying his or her vehicle through the smart device, electronically retrieving vehicle history records for the vehicle identified as satisfying the at least one search criterion, identifying a service record in the server database, the service record being indicative of ownership of the vehicle, electronically receiving from the customer at least one concern related to a vehicle defect in performance or a selected service selected from available services, electronically generating a service report based (i) on the correlation between the diagnostic information and a database of diagnostic solutions database and (ii) the prices of the selected services, and preparing a repair order after querying a secondary system having at least information specific to vehicle and manufacturer of the vehicle. The method can include steps such as electronically forwarding the service report to a technician for review, collecting the vehicle from the customer, allowing the technician to propose recommended actions based on an examination of the vehicle and the service report, transmitting recommendations to the customer for approval by the customer, wherein the customer may electronically approve some or all of the recommendations, and preparing a repair order after querying a secondary system having at least information specific to vehicle and manufacturer of the vehicle.

In another embodiment, the method can include the steps of determining whether the customer is a candidate for purchasing additional services based the vehicle service records; and querying the secondary system to determine the status of any recalls on the vehicle; and querying the customer as to whether the customer would like any of the additional services.

In another embodiment, the method can include the steps of electronically forwarding the service report to the parts department to determine needed parts, pricing of parts, availability of parts, location for obtaining parts, and discounts for purchasing parts.

In another embodiment, the smart device has an application with a payment mechanism to allow a customer to pre-pay for any parts or services.

In another embodiment, the method for automating routine servicing of a vehicle comprises providing a smart device having a processor and a transceiver, querying the customer as to which service among a list of available services is desired by the customer via an application on the smart device; accessing a services database from the smart device, wherein the services database is in communication with a secondary system having at least information specific to vehicle and manufacturer of the vehicle, and the secondary system comprises a Dealer Management System; correlating the selected service to information in the services database; optionally electronically generating an instruction to a technician to perform the selected services on the vehicle; and electronically generating a repair order report.

In another embodiment, the method can include a server database that may be accessed via the Internet.

Another embodiment, a vehicle system for improving efficacy of vehicle servicing has a smart device for allowing a customer to input information about the vehicle; a terminal or smart device for allowing a technician to review the information; a database containing information related to vehicles, wherein the database is at a dealer management system; and a repair order or service report generator capable of generating a service report based on the information and technical data provided by the technician; and a server database connected to the console capable of communicating with a dealer management system. The server database provides one or more service reports, from the server database, to a second vehicle service center upon request and authentication.

In another embodiment, the computer-implemented method for self-service by a customer during a visit to a vehicle service center includes the steps of providing identification information of a vehicle via a smart device or computer located away from the service center, the console comprising a touch-screen display device; after confirming the identification information, verifying personal information from the customer via the smart phone and updating the personal information at the smartphone; accessing a server database and a secondary system to obtain vehicle history data corresponding to the vehicle, wherein the secondary system comprises a dealer management system; storing the vehicle history data on the server database; querying concerns of the customer, the concerns are related to the vehicle; displaying recommendation for the vehicle based on the concerns and preventative measure that are upcoming for the vehicle on the smart device; displaying the preventive measures that are overdue for the vehicle on the smart device; and notifying a technician that the customer has checked into the service center and the vehicle is ready for inspection and further processing by the technician, electronically generating a repair order having comments from the technician and the customer; electronically transmitting the repair order to a server database; and providing the repair order or the vehicle history data to a second vehicle service center upon request and authentication. The method may have the further step of verifying warrantee information of the vehicle. The method may also allow the customer to address a query about the concerns by identifying the concerns on a pictorial representation of the vehicle.

In another embodiment, a smart device may be a smartphone (e.g., Iphone®), computer, or a set-top box (e.g. Roku® or Apple TV®).

Certain embodiments addressed a variety of metrics that are to be met by vehicle service centers. These methods and systems may be capable of improving the quality of vehicle service by increasing awareness of customers in offered preventive services and issues that need to be discussed/addressed during the service visit, improving the efficient operation of vehicle care by increasing the overall breadth of vehicle issues that may be addressed during a customer encounter, significantly decreasing provider encounter times, decreasing the number of clerks needed to staff the check-in window, thus, freeing the clerks up to do other activities, increasing the number of check-in points available to customers in addition to the check-in window, thus, reducing check-in time by up to ten minutes during peak hours, increasing third party collections because of the improved collection of third party payers including warrantee insurance companies, increasing the participation of the customers in the process and verification of information, and the interface is easily understood by first-time users.

Specific embodiments can be embodied in the form of computer-implemented processes and apparatus for practicing those processes. The present disclosure can also be embodied in the form of computer program code including computer-readable instructions embodied in tangible media, such as CD-ROMs, hard drives, or any other computer-readable storage medium, wherein, when the computer program code is loaded into and executed by a computer, the computer becomes an apparatus for practicing the disclosure. When implemented on a computer, the computer program code segments configure the computer to create specific logic circuits or processing modules.

As disclosed herein, the devices and components of the systems and methods may be in direct or indirect communication with a dealer management system. It should be appreciated that such communication may include the devices or components writing to the dealer management system. For example, the dealer management system may be updated by the devices and/or components to include subsequent services performed on a vehicle, not previously included within the dealer management system. This may include updating the dealer management system to include information contained within a generated service report, as disclosed herein.

While the best mode for carrying out the disclosure has been described in detail, those familiar with the art to which this disclosure relates will recognize various alternative designs and embodiments for practicing the disclosure as defined by the following claims.

What is claimed is:

1. A method for improving the efficiency of vehicle servicing at a vehicle service center comprising the steps of:
receiving, from a smart device, a service from a list of services to be performed on the vehicle, the list of services being included within a services database accessible by the smart device, the services database being in communication with a dealer management system having information specific to the vehicle;
retrieving vehicle history records for the vehicle from a vehicle history database;
receiving, from the smart device, a concern related to the vehicle;
retrieving diagnostic solutions correlated with the concern from a diagnostic solutions database;
generating a service report including the diagnostic solutions correlated with the concern and prices corresponding to the diagnostic solutions; and
preparing a repair order after querying a secondary system having information specific to a manufacturer of the vehicle.

2. The method of claim 1 further comprising the step of:
updating the dealer management system to reflect the service report.

3. The method of claim 1 further comprising the step of:
forwarding the service report to a technician.

4. The method of claim 3further comprising the step of:
receiving recommendations from the technician, the recommendations being based upon an examination of the vehicle and the service report.

5. The method of claim 4 further comprising the step of:
transmitting the recommendations to the smart device for approval by a customer.

6. The method of claim 5 further comprising the step of:
receiving, from the smart device, approval for at least a portion of the recommendations.

7. The method of claim 1 further comprising the steps of:
determining whether additional services are performable on the vehicle based upon the vehicle history records; and
querying the secondary system to determine whether the vehicle has any outstanding recalls.

8. The method of claim 7 further comprising the step of:
transmitting, to the smart device, a supplemental report evidencing the additional services and outstanding recalls.

9. The method of claim 1 further comprising the step of:
transmitting the service report to a parts department, the parts department determining needed parts, pricing of parts, availability of parts, locations of parts, and discounts.

10. The method of claim 1 further comprising the step of:
receiving, from the smart device, a pre-payment for at least one of parts and services.

11. A method for automating routine servicing of a vehicle comprising the steps of:
receiving, from a smart device, a service from a list of services to be performed on the vehicle, the list of services being included within a services database accessible by the smart device, the services database being in communication with a dealer management system having information specific to the vehicle;
correlating the received service with information included within the services database; and
generating a repair order report.

12. The method of claim 11 further comprising the step of:
transmitting instructions to a technician to perform the received service on the vehicle.

13. A system for improving efficacy of vehicle servicing comprising:
a smart device receiving vehicle information from a customer;
a technician device in communication with the smart device and allowing a technician to review the vehicle information;
a vehicle database in communication with the device, the vehicle database including information related to vehicles, the vehicle database being included within a dealer management system in communication with service centers;
a services database in communication with the smart device, the technician device, and the dealer management system, the services database including service history specific to the vehicle, the history specific to the vehicle being communicable with the service centers over the dealer management system upon request and authentication; and
a service report generator generating a service report based on the vehicle information and information provided by the technician, the dealer management system being updated according to information contained within the service report.

14. A method for self-service by a customer during a visit to a vehicle service center comprising the steps of:
transmitting, by a smart device, vehicle identifying information;
transmitting, by the smart device, customer information corresponding to the vehicle identifying information;
accessing, by the smart device, a vehicle history database including vehicle history information specific to the vehicle, the vehicle history database being in communication with a dealer management system;
transmitting, by the smart device, a concern about the vehicle;
receiving, by the smart device, a recommendation for the vehicle based on the concern, overdue services for the vehicle, and comments of a technician, the overdue services being determined from the vehicle history information and a suggested services list included within the dealer management system; and
transmitting, by the smart device, the recommendation to a server database, the server database being in communication with vehicle service centers.

15. The method of claim 14 wherein the recommendation is communicable from the server database to the vehicle service centers upon request and authentication.

16. The method of claim 14 further comprising the step of:
receiving, by the smart device, warrantee information specific to the vehicle.

17. The method of claim 14 wherein the concern about the vehicle is depicted on a customer alterable pictorial representation of the vehicle.
